(19) United States
(12) Patent Application Publication
(10) Pub. No.: US 2025/0206215 A1
(43) Pub. Date: Jun. 26, 2025

(54) MODULE SUPPORT ARRANGEMENT

(71) Applicant: Faurecia Autositze GmbH, Hannover (DE)

(72) Inventors: Tomasz Stasinski, Dzierzoniow (PL); Piotr Ceglarek, Katowice (PL); Adrian Malik, Wroclaw (PL); Slawomir Filip, Grabianów (PL)

(73) Assignee: Faurecia Autositze GmbH, Hannover (DE)

(21) Appl. No.: 18/980,140

(22) Filed: Dec. 13, 2024

(30) Foreign Application Priority Data
Dec. 21, 2023 (DE) 102023136243.7

(51) Int. Cl. B60N 2/90; B60N 2/58; B60N 2/72

(52) U.S. Cl. CPC B60N 2/914; B60N 2/5891; B60N 2/72

(57) ABSTRACT

A module support arrangement for attachment to the seat structure of a motor vehicle seat and for fixing pneumatic components or non-pneumatic components includes a module support with a front side and a rear side opposite the front side and optionally at least one further component. Air ducts and/or air duct sections are integrated into the module support and/or into the at least one further component. At least one of the air ducts or air duct sections has, at least locally, a change in the cross-sectional area.

### CROSS REFERENCE TO RELATED APPLICATIONS

This application claims priority on and the benefit of German patent application number 10 2023 136243.7 having a filing date of 21 Dec. 2023.

### BACKGROUND OF THE INVENTION

### Technical Field

The invention relates to a module support arrangement.

### Prior Art

Such module support arrangements, which are known e.g. from EP 38 45 415 A1, are generally attached to a vehicle seat structure and are designed to fasten thereto certain functional components, such as fluid actuators, valve blocks or pumps. In addition, the module support arrangements are also used to fasten the corresponding lines for transporting air to the individual components. In general, such module support arrangements are found in vehicle seats behind the seat padding of the backrest or seat section. With the known systems, the functional components usually have to be attached individually to the module support. This requires fastenings for lines, valve blocks, pumps, etc. The number of components required for complete assembly, and therefore the number of components required, is relatively high with this approach. Additional components are required especially also when special requirements are placed on the properties of the lines. The size and shape of the cross section of lines influence not only the flow rate but also the type of flow, i.e. whether it is laminar or turbulent. However, the type of flow also influences the acoustics of such a pneumatic system. It can therefore sometimes be advantageous if the shape and cross section of the air lines used are adjusted according to the acoustic requirements. Traditionally, this means that different line sections must be provided as separate components.

### BRIEF SUMMARY OF THE INVENTION

Therefore, the object of the present invention is to create a module support arrangement, with which the required number of components is reduced compared to the prior art.

This object is achieved by a module support arrangement for attachment to the seat structure of a motor vehicle seat and for fixing pneumatic components or non-pneumatic components, comprising a module support with a front side and a rear side opposite the front side and optionally at least one further component, wherein air ducts and/or air duct sections are integrated into the module support and/or into the at least one further component, wherein at least one of the air ducts or air duct sections has, at least locally, a change in the cross-sectional area, and by a vehicle seat comprising a seat frame structure and a module support arrangement as taught herein which is suspended from the seat frame structure via a suspension. Advantageous embodiments can be found in the dependent claims.

The present invention reduces the number of required components by already integrating parts of the line system into the module support arrangement or into the support material of the same. Thus, according to the invention, the fluid lines are no longer in the form of hoses or the like but rather are in the form of air ducts or at least air duct sections which are already integrated into the support material of the module support arrangement. In order to close any ducts that may still be open, only one further component, e.g. a cover, is then required. Thus, a complex installation of fluid hoses is no longer necessary and the number of components is greatly reduced.

The module support arrangement according to the invention, which is used for attachment to the seat structure of a motor vehicle seat and for fixing pneumatic components or non-pneumatic components, has a module support with a front side and a rear side opposite the front side. Optionally, the module support arrangement has at least one further component. In the module support arrangement according to the invention, i) air ducts and/or ii) air duct sections are integrated into the module support and/or into the at least one further component. Such air duct sections can be recessed, preferably relative to the rear side and/or relative to the front side. In the case of alternative i), complete air ducts can be integrated. This eliminates the need to additionally attach air conducting lines and reduces the number of components to be used.

According to the invention, at least one of the air ducts or air duct sections has, at least locally, a change in the cross-sectional area. Preferably, the mentioned change in the cross-sectional area or changes in the cross-sectional area are found in the region between the two ends of an air duct or air duct section. The cross-sectional area can be changed once or several times within at least one air duct section. It is conceivable, for example, that in a sequence a plurality of narrowings and/or widenings of the cross section or of the cross-sectional area of an air duct or air duct section are present, preferably in a region between the two ends thereof. The term “cross-sectional area” refers to the area of the cross section of the air ducts or air duct sections transverse to their longitudinal direction or main flow direction or, in general, transverse to the flow path. “Cross section of the flow path” thus means the cross-sectional profile of the fluid-flow/air-flow region of the air ducts or air duct sections. The changes in cross-sectional areas usually lead to a change in the flow behavior of the flowing medium and thus to a change in the oscillations generated in the medium. The changes should preferably reduce unwanted noise.

In a preferred embodiment, the change in the cross-sectional area or the cross section of the flow path comprises at least a local and/or continuous reduction or widening and/or shape change of the cross-sectional area or the cross section of the flow path. Due to the change in the cross section, the velocity of the medium flowing through is changed, and the length of resonance sections also changes, which leads or can lead to a change in the oscillation of the medium. Furthermore, turbulences within the flow can occur precisely at the points of change, which turbulences interrupt laminar flows in particular. This leads to a change in the oscillations generated within the flow, with a reduction in noise being particularly preferred.

Particularly preferably, the cross-section change is realized by a changed width and/or height and/or cross-sectional geometry of an air duct or air duct section. The cross-sectional geometry can be rectangular, round, oval, flat or in the form of a regular or irregular polygon, with each of the different cross sections producing its own, quite characteristic oscillation behavior. A change in the cross-sectional geometry can thus lead to a broader oscillation spectrum and can attenuate an interfering noise which is characteristic per se as a result.

In the case of alternative ii), it is particularly preferred that air duct sections are integrated, preferably recessed, in such a way that each of the air duct sections comprises open long sides, with the module support or the at least one further component being used as a cover which closes the open long sides of the air duct sections in such a way that air ducts are thereby created. Open long sides are created, for example, by only having grooves of U-shaped cross section in the module support, said grooves being open to one side, the long side. Preferably, if air duct sections with open long sides are present, a cover is also provided which closes the open long sides of the air duct sections in such a way that air ducts are thereby created. Air ducts created in this way or already present are then designed such that air can enter or exit preferably only at the ends located in the direction of flow. Branches or openings between the ends are conceivable in principle. Separate attachment of air lines or hoses can be avoided in this way, which saves assembly effort and also saves additional components, since the cover can cover a plurality of air duct sections at the same time. The cover can also be part of a housing which is designed to accommodate a further pneumatic component, for example a valve block or a pump. In this way, integration can be increased even further.

Preferably, the module support has a recess in which the integrated air duct sections are arranged. When the further component, e.g. in the form of a cover, is then inserted into the recess, preferably in a form-locking manner, the further component is automatically correctly positioned in order to close the corresponding open long sides, which further simplifies assembly. A further component or cover itself can feasibly also be made of several parts.

The material of the module support and/or of the further component can be designed in different ways. According to preferred embodiments, it can be provided, among other things, that the material comprises or consists of a plastic material, a foil material, or a felt material. The support material or the module support arrangement can be a part formed by injection molding or formed by thermoforming or have such a part.

Other parts can also be integrated into the module support arrangement according to the invention. Preferably, it can be provided, for example, that the module support comprises integrated fastening sections for attaching or accommodating pneumatic components and/or non-pneumatic components. The pneumatic components can be selected from the following group, for example: pump, valve block, fluid actuator. For example, a non-pneumatic component can be selected from the group comprising the following: vibration system component, ventilation system component, electrical component, wiring harness, connector, cover. The optional additional component can be a pneumatic or non-pneumatic component.

According to the invention, sections to which hose lines or fluid actuators can be fastened can be provided on the module support.

Finally, the invention relates to a vehicle seat that has a seat frame structure and a module support arrangement as described above, which is suspended therefrom via a suspension.

### BRIEF DESCRIPTION OF THE DRAWINGS

The invention is explained in more detail below with reference to FIGS. 1-10.

FIG. 1 shows a schematic, lateral exploded view of an exemplary embodiment of a module support arrangement according to the invention, in sectional view.

FIG. 2 shows the embodiment shown in FIG. 1, as a simple sectional view.

FIG. 3 shows a plan view of the front side of an example of a module support according to the invention as part of a module support arrangement.

FIG. 4 shows a perspective view of detail D of the module support shown in FIG. 3.

FIG. 5 shows an enlarged view of detail D from FIG. 3.

FIG. 6 shows a cross section through a constriction of a flow path corresponding to section III in FIG. 5.

FIG. 7 shows a cross section through a flow path as in FIG. 6, with an alternative cross section being shown.

FIG. 8 shows a cross section of a flow path corresponding to section I in FIG. 5.

FIG. 9 shows a longitudinal section of a flow duct corresponding to section II in FIG. 5.

FIG. 10 shows the cross section of an alternative constriction in a flow path.

### DETAILED DESCRIPTION OF PREFERRED EMBODIMENTS

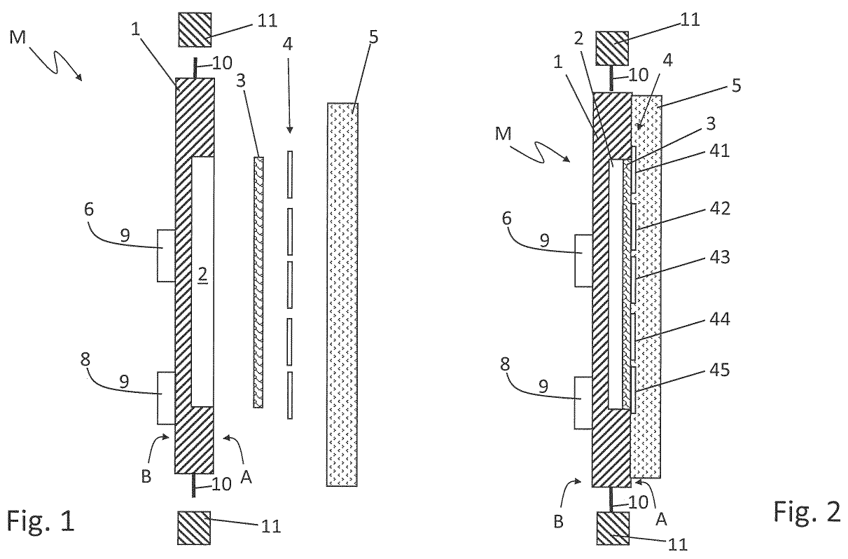

FIGS. 1 and 2 show a sectional view of an exemplary structure of a module support arrangement M according to the invention, in FIG. 1 in exploded view, in FIG. 2 in assembled view.

The module support 1 has a front side A and a rear side B. In general, the front side A will point in the direction of travel of a vehicle seat fitted with the module support arrangement M according to the invention. Only the seat frame structure 11 and a seat pad 5 of such a vehicle seat are indicated here. The module support 1 can then be attached to the seat frame structure 11 by means of a suspension 10, which in the simplest case can be metal wires or the like.

The module support 1 is preferably made of a material that preferably contains plastic, a film, or felt. In a preferred embodiment, a recess 2, which is not absolutely necessary, is arranged in the module support 1, preferably a recess accessible from the front side A. The module support 1 has, preferably in the bottom of the recess, air duct sections (not shown in more detail here) or even complete air ducts, which are part of a pneumatic system installed on the module support 1 as part of the module support arrangement M according to the invention. In addition to a line system formed by the air ducts, the pneumatic system can have further components, for example pneumatic components, such as a valve block 6 and/or a pump 8.

In the example shown, the module support arrangement M also comprises a further component, here in the form of a cover 3, which can be attached to the module support 1—preferably in a form-locking manner if a recess 2 is present—in order to cover air duct sections present there and to prevent the air flowing through them from escaping to the outside. If complete air ducts are already present in the module support 1, such a cover is not necessary. However, it is also possible, alternatively or additionally, to integrate corresponding air duct sections into the mentioned further component 3. The complete air ducts are then likewise created by joining the module support 1 and the further component 3. Fluid actuators, which are preferably fluid-fillable bladders, with the aid of which a seat adjustment function or even a massage function can be realized, are indicated by reference sign 4 or reference signs 41-45. These fluid actuators 4, 41-45 likewise form components of the pneumatic system and can be connected to air ducts present in the module support 1 and/or in the further component 3 and thereby supplied with air. A seat padding 5 can then be attached to the front side A over the fluid actuators 4, 41-45.

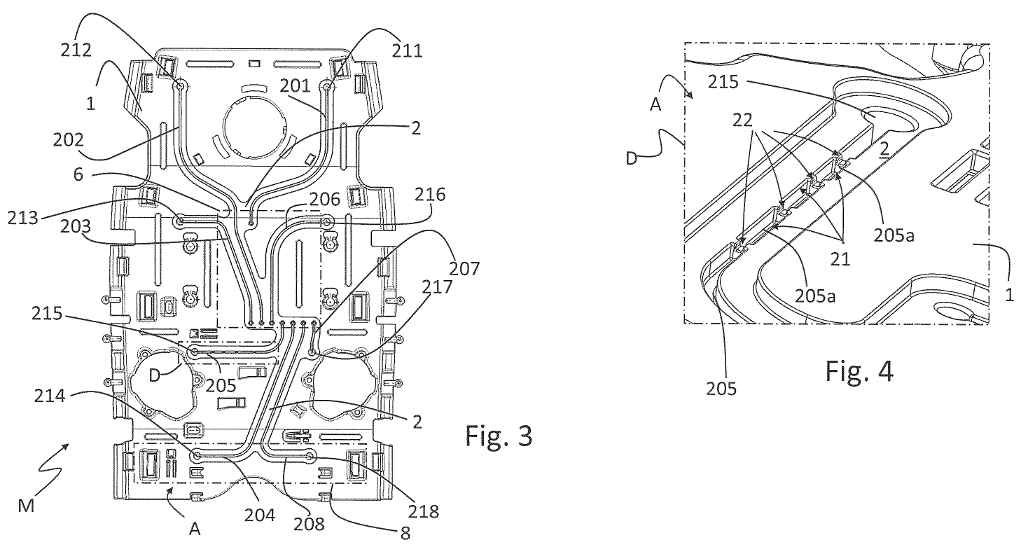

A plan view of the front side A of the module support arrangement M according to the invention, more precisely a plan view of the module support 1 of the module support arrangement, is shown in FIG. 3. One can see the recess 2 and air duct sections 201-208 arranged therein such that they are recessed relative to the recess 2. These air duct sections 201-208 have, at one end thereof, corresponding ports 211-218 which are used to connect the fluid actuators described above to the air conducting system. The fluid actuators can be connected to these ports 211-218 either directly or, for example, by means of a short hose.

FIG. 4 shows a perspective view of detail section D of FIG. 3. In the region of the recess 2 in the module support 1, an air duct section 205 which opens into a port 215 is recessed. A fluid actuator 4 (not shown here) is arranged at the port 215, this fluid actuator being filled and/or emptied via this air duct section 205, which thus forms a flow duct for the fluid actuator 4. Cross-section changes in the form of constrictions 22 are inserted into the cross section of the duct section 205, this cross section being homogeneous per se in this exemplary embodiment. In this example, the constriction 22 of the cross section occurs both in the height of the air duct section 205 and in the width. The sections 21 are wider than the sections 22. In the example shown, these cross-section changes 21, 22 are used to form, for example, various sub-chambers 205a, which are connected via the cross-section changes 22. The sub-chambers 205a are preferably of different lengths, so that, in the event of an oscillation of the fluid, different resonances form in each of the sub-chambers 205a and therefore there is no amplifying effect of individual oscillation frequencies. Preferably, the geometry of such a sub-chamber 205a is selected such that the possible resonance frequencies lie outside the perception range of human hearing and thus do not disturb a user of the vehicle seat.

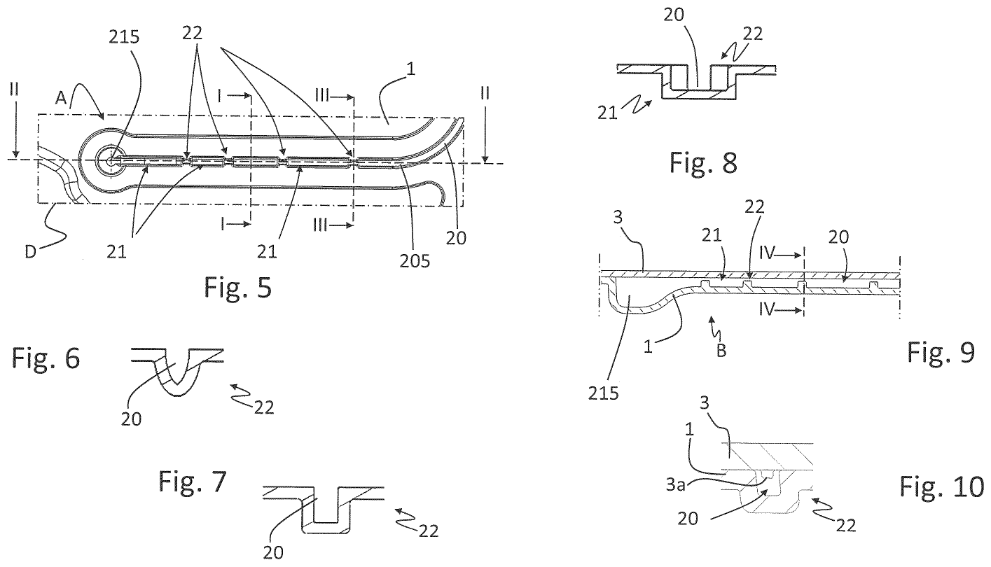

FIG. 5 shows a plan view of detail section D of FIG. 3 with an air duct section 205, which leads to a port 215 and thus forms a flow path 20. The flow path has constrictions 22 and widenings in the section shown. The widenings 21 shown here form sub-chambers, which have the same cross section but are of different lengths. As a result, each sub-chamber has a different natural frequency as the fluid flows through it.

FIGS. 6 and 7 each show a cross section of an exemplary constriction 22 as shown in section III of FIG. 5. In FIG. 6, the flow path 20 has a semioval cross section, while in FIG. 7 it is rectangular. The shape is largely arbitrary and can therefore be adapted to the desired flow behavior of the fluid.

FIG. 8 shows a cross section of a flow path 20 through a widening 21 as shown by section I of FIG. 5. The cross section is rectangular in this case. The constriction 22 following in the course of the flow path 20 is achieved, in this case, by the reduction of the width, while the cross section remains rectangular.

The sectional view shown in FIG. 9 corresponds to section II in FIG. 5 and is a longitudinal section through the flow path 20. The flow path 20 is recessed into the surface of the module support 1 and ends in the port 215, where a fluid actuator 4 (not shown) is/can be connected. In this embodiment example, the flow path is closed by the cover 3. In this example, the constriction 22 of the flow path 20 is achieved by elevations from below, which reduce the cross section in height. In this example too, it can be seen that the widenings 21 are of different lengths.

FIG. 10 shows a further embodiment of a constriction 22 in cross section. The flow path 20 is recessed into the module support 1 and has a uniform, here almost rectangular, cross section. The constriction 22 of the flow path 20 is achieved by a cover addition 3a, which protrudes into the flow path 20 when the flow path 20 is closed by the cover 3 and which thus leads to a constriction of the flow path.

Pressure fluctuations, switching operations or simply the flow of a fluid through a flow path 20 can cause the fluid to oscillate. The geometry of the space in which the fluid oscillates creates resonances that can produce quite an interfering noise toward the outside. With a module support arrangement according to the invention, this resonance space can be changed by cross-section changes 21, 22 in such a way that the oscillation occurring is divided into a plurality of different oscillations and thus loses intensity and thus prevents or at least greatly attenuates interfering noises.

What is claimed is:

1. A module support arrangement (M) for attachment to the seat structure of a motor vehicle seat and for fixing pneumatic components (6, 8; 41-50) or non-pneumatic components, comprising a module support (1) with a front side (A) and a rear side (B) opposite the front side (A) and optionally at least one further component (3), wherein
i) air ducts and/or
ii) air duct sections (201-210) are integrated into the module support (1) and/or into the at least one further component (3), wherein
at least one of the air ducts or air duct sections (201-210) has, at least locally, a change (21, 22) in the cross-sectional area.

2. The module support arrangement (M) according to claim 1, wherein the change (21, 22) in the cross-sectional area comprises at least a local and/or continuous reduction (22) or widening (21) and/or shape change of the cross-sectional area (20).

3. The module support arrangement (M) according to claim 2, wherein the cross-sectional change (21, 22) is realized by a changed width and/or height and/or cross-sectional geometry of an air duct or air duct section (201-210).

4. The module support arrangement (M) according to claim 1, wherein in the case of alternative ii) the air duct sections (201-210) are integrated, preferably recessed, in such a way that each of the air duct sections (201-210) comprises open long sides, wherein the module support (1) or the at least one further component (3) is used as a cover (3) which closes the open long sides of the air duct sections (201-210) in such a way that air ducts are thereby created.

5. The module support arrangement (M) according to claim 3, wherein the module support (1) has a recess (2) in which the integrated air duct sections (201-210) are arranged and wherein the at least one further component (3) is inserted into the recess (2).

6. The module support arrangement (M) according to claim 1, wherein the module support (1) and/or the at least one further component is an injection-molded part or a part formed by thermoforming.

7. A vehicle seat comprising a seat frame structure and a module support arrangement (M) according to claim 1, which is suspended from the seat frame structure via a suspension (10).
